(19) United States
(12) Patent Application Publication
(10) Pub. No.: US 2026/0071664 A1
(43) Pub. Date: Mar. 12, 2026

(54) Blocker and Compression Damping Structure

(71) Applicant: Eko Sport, Inc., Grand Junction, CO (US)

(72) Inventor: Darek C. Barefoot, Grand Junction, CO (US)

(73) Assignee: Eko Sport, Inc., Grand Junction, CO (US)

(21) Appl. No.: 19/318,524

(22) Filed: Sep. 4, 2025

Related U.S. Application Data
(60) Provisional application No. 63/693,359, filed on Sep. 11, 2024.

(51) Int. Cl. F16F 9/49; B60G 15/06; B62K 25/04; F16F 9/06

(52) U.S. Cl. CPC F16F 9/49; B60G 15/062; B62K 25/04; F16F 9/06; B60G 2202/24; B60G 2202/312; B60G 2206/41; B60G 2206/426; B60G 2300/12

(57) ABSTRACT

A damper system for a bicycle shock absorber incorporates a blocker and a tapered spring. The blocker at least partially blocks a passageway for incompressible fluid between a compression chamber and a reservoir chamber during a portion of the compression stroke. The taper of the spring allows the loops of the spring to rest at least partially laterally relative to one another.

### BACKGROUND OF THE INVENTION

The present disclosure relates to a suspension system or shock absorber for a bicycle. More specifically, the present design relates to a suspension system for a bicycle, where an incompressible fluid is used as a damping medium. Further, the present design relates to a blocker that affects fluid flow only during certain portions of the stroke to provide a more comfortable ride.

In many dampers that include an incompressible fluid, the pressure of the fluid may increase during a compression portion of a stroke and may decrease during a rebound portion of a stroke. In such structures, it may be desirable to include a reservoir chamber at one end of a suspension system. In these structures, the incompressible fluid may flow from a compression chamber directly or indirectly into the reservoir chamber as a piston is pressed into the compression chamber. Forces on the shock absorber may, on occasion, be high enough to overcome the resistance of the conventional spring means combined with a conventional arrangement for fluid damping. Accordingly, a resilient bumper is commonly provided at the end of a compression chamber to prevent metal parts from contacting and damaging each other on such occasions. A bumper provided for this purpose, either of rubber or other elastomeric material, may still reach its compressive limit relatively abruptly, and transmit an undesirable end-of-stroke jounce called “hard bottom out” or “harsh bottom out” to the bicycle rider.

Different systems have been developed to minimize the effects of bottom out and smoothly decelerate the movement of the shock absorber as it reaches the end of its stroke. Some systems incorporate an auxiliary piston or post in addition to the main damping piston, and a corresponding auxiliary bore, cavity, or other receiving feature. Near the end of the compression stroke, fluid is trapped between these features and allowed to flow out only at a restricted rate. The added hydraulic resistance from this arrangement smooths deceleration under rapid, high compressive force. However, the distance over which this arrangement may act to add hydraulic resistance will generally be smaller than the axial length of the auxiliary mating features (post plus cavity) when they are fully engaged at end of stroke. For example, if the length of the fully engaged parts is twenty millimeters from the base of the post to the floor of the receiving cavity, then the device will add resistance at most to just under twenty millimeters of shock travel. Continuing with this example, the twenty-millimeter engaged length of the auxiliary parts must be added to what would otherwise be the shortest possible axial length of the damper. Since, for reasons known in the art, it is advantageous to keep the ratio of a shock's overall mounted length to its stroke as low as possible, the just described arrangement for controlling bottoming force requires an undesirable compromise to the shock's architecture. In other systems, an electronic device is incorporated to adjust fluid flow based on internal pressure. However, such devices require the use of a battery or other electric power generation system. The electronics can be difficult to adjust for an end user and can also increase weight.

Accordingly, in many embodiments, it may be desirable to include a damper system that allows for elevated mechanical damping of fluid near the end of the stroke of the shock absorber. It may be desirable for the damper system to be easily incorporated into an existing design with minimal effect on the length of the compression chamber. Such embodiments may improve manufacturability and damper performance.

### BRIEF SUMMARY OF THE INVENTION

In a first embodiment, a suspension or shock absorber for a vehicle may include a first end, a second end, a barrier assembly, a spring, and a blocker. The first end may include a piston. The second end may be capable of telescopically reciprocating with the first end and may at least partially define a compression chamber. The compression chamber may have at least one wall. The barrier assembly may be between the compression chamber and a reservoir chamber. The spring may be attached to the piston. The blocker may be attached to the spring. The blocker may at least partially define at least one fluid passageway. The blocker may have a peripheral edge configured to contact the at least one wall of the compression chamber.

The barrier assembly may include at least one aperture defined in at least one wall of the compression chamber. The at least one aperture may be substantially circular. The barrier assembly may further include at least one flow route between the at least on aperture and the reservoir chamber. Fluid may be permitted to flow between the compression chamber and the reservoir chamber by flowing through the at least one aperture and the at least one flow route.

The blocker may have a diameter. The piston may have a diameter. The compression chamber may have a diameter. The diameter of the blocker, the diameter of the piston and the diameter of the compression chamber may be substantially the same or substantially equal. The peripheral edge of the blocker may have a height adequate to minimize co-axial deviation of the blocker relative to the corresponding wall of the compression chamber.

The fluid passageway may allow fluid to flow adjacent a central area of the blocker. The fluid passageway may allow fluid to flow adjacent a peripheral area or peripheral edge of the blocker.

The spring may be tapered. A spring retainer may be between the spring and the piston. The spring retainer may be removable from the piston.

The blocker may be radiused between one portion of the peripheral edge and a bottom. The blocker may have a taper between one portion of the peripheral edge and a bottom. The blocker may be configured to move within the compression chamber. The compression chamber may include a stop surface that defines an extreme position for the blocker.

In another embodiment, a suspension or shock absorber for a vehicle may include a first end, a second end, a tapered spring, and a blocker. The first end may include a piston. The second end may be capable of telescopically reciprocating with the first end and may at least partially define a first chamber. The tapered spring may be attached to the piston. The tapering of the spring may allow at least two loops of the tapered spring to be positioned at least partially laterally relative to one another when compressed. The blocker may be attached to the spring. The blocker may be spaced from the piston.

A second chamber may be in fluid communication with the first chamber. A barrier assembly may at least partially define the fluid communication between the first chamber and the second chamber. The barrier assembly may include at least one aperture defined in at least one wall of the first chamber. The barrier assembly may further include at least one flow route between the at least one aperture and the second chamber.

The blocker may have a peripheral edge configured to contact at least one wall of the first chamber. The peripheral edge of the blocker may have a height adequate to minimize co-axial deviation of the blocker relative to the corresponding wall of the first chamber. The blocker may at least partially define a fluid passageway that affects fluid flow through the barrier assembly. The fluid passageway may allow fluid to flow adjacent a central area of the blocker. The fluid passageway may allow fluid to flow adjacent a peripheral area of the blocker.

A spring retainer may be positioned between the spring and the piston. The spring retainer may be removable from the piston.

The blocker may be radiused between at least one portion of the peripheral edge and a bottom. The blocker may have a taper between one portion of the peripheral edge and a bottom. The first chamber may include a stop surface that defines an extreme position for the blocker.

The blocker may have a diameter. The piston may have a diameter. The first chamber may have a diameter. The diameter of the blocker, the diameter of the piston and the diameter of the first chamber may be substantially the same or substantially equal.

### BRIEF DESCRIPTION OF THE SEVERAL VIEWS OF THE DRAWINGS

FIG. 1 is a perspective view of a bicycle showing the general configuration and position of the shock absorbers according to the disclosed embodiments;

FIG. 2 is a perspective view of a rear shock of a bicycle according to the disclosure;

FIG. 3 is a perspective view of one embodiment of a blocker assembly according to the disclosure;

FIG. 4 is a cross-sectional view of the embodiment of FIG. 2, taken along line 4-4 incorporating the blocker of FIG. 3 and showing the shock absorber in an extended position;

FIG. 5 is the same cross-sectional view as FIG. 4, showing the shock absorber in a partially compressed position;

FIG. 6 is a close view of the portion of FIG. 5 that is shown in the circle numbered 6 in FIG. 5;

FIG. 7 is the same cross-sectional view as FIG. 4, showing the shock absorber in a compressed position;

FIG. 8 is a perspective view of another embodiment of a blocker assembly according to the disclosure;

FIG. 9 is the same close view as FIG. 6 showing the blocker assembly of FIG. 8 and an alternative configuration of a rear shock;

FIG. 10 is an exterior front view of a front fork shock absorber of a bicycle according to the disclosed embodiments;

FIG. 11 is a perspective view of another embodiment of a blocker assembly according to the disclosure;

FIG. 12 is a cross-sectional view of one leg of FIG. 11, taken along line 12-12 of FIG. 11;

FIG. 13 is a close view of the leg of FIG. 12 within the area shown by the dashed lines 13 in FIG. 12 showing the leg in an uncompressed position; and

FIG. 14 is a close view similar to FIG. 13, showing the leg in a compressed position.

In describing the preferred embodiment of the invention, which is illustrated in the drawings, specific terminology will be resorted to for the sake of clarity. However, it is not intended that the invention be limited to the specific term so selected, and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In this detailed description, various terms relating to direction may be used. The elements discussed herein relate to a bicycle. Because, in its operable position, a bicycle is oriented generally vertically, i.e., perpendicular to the ground, the direction terms refer to the position of an element relative to gravity when the bicycle is in its operable position. Accordingly, for example, the term “downwardly” refers to the direction towards the ground when the bicycle is in its operable position, and the term “forwardly” relates to a direction towards a front wheel of the bicycle when it is in its operable position. Further, the terms “inboard” and “outboard” may be used. The term “inboard” describes a position between one item and a vertical plane substantially bisecting the bicycle. The term “outboard” describes a position of an object further from the vertical center plane of the bicycle. In addition, the terms “bicycle” and “bike” are used herein interchangeably. A person having ordinary skill in the art will understand that if something is referred to as one, it can refer to the other.

In the present disclosure, the suspension structure may be described as it relates to a bicycle. However, the suspension structure described in the present embodiments may instead be applied to other vehicles. The present suspension structure may be used with vehicles having a different number of wheels, for example. The suspension structure may be used in connection with a motorized vehicle. In the present disclosure, the terms “fork”, “suspension” and “shock absorber” may be used somewhat interchangeably. A person of ordinary skill in the art is able to understand the nuances between these terms and understand their use interchangeably in the disclosure. The present disclosure describes a suspension system that may be at least partially filled with a compressible gas and at least partially with a substantially incompressible fluid. In the descriptions herein, it will be understood by a person having ordinary skill in the art that the pressure within the suspension unit at the beginning of a suspension stroke may be substantially in equilibrium throughout the suspension system. A user may select from a variety of pressures within the suspension unit, depending on the user's preferences regarding ride and handling and the demands of a particular course the rider desires to ride. These factors are all well-known in the art and are not described in detail herein.

The structures described herein may be applied to either a front or rear suspension of a vehicle, most particularly a bicycle. The remaining structures present in the suspension may be illustrated and may be described in at least a cursory fashion. However, these structures are not critical to the use of the embodiments described herein. The present embodiments could be incorporated with other suspensions that use a compressible gas and an incompressible fluid. Accordingly, the suspension system elements shown should not be construed as being limiting to the embodiments described.

In general, persons of ordinary skill in the art are familiar with the structural and functional differences and limitations between shock absorbers and can make the necessary modifications to use the structures described herein in context. However, a person of ordinary skill in the art is able to understand that any of the disclosed embodiments could, in theory, be used in another suspension system in current operation or later developed.

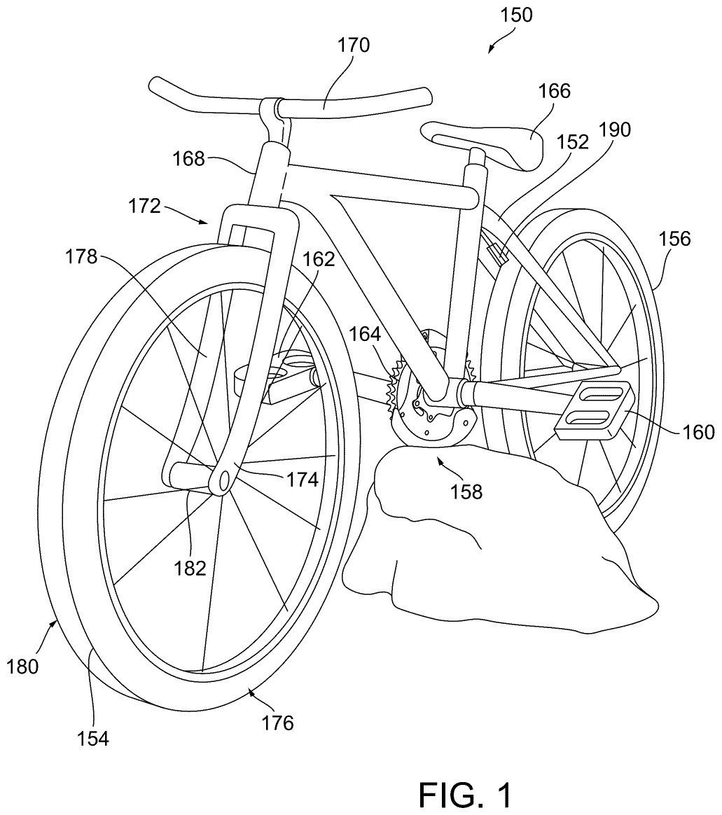

The overall configuration of the present device in the context of a vehicle is shown in FIG. 1. Many of the parts are shown schematically in this FIG., in an overall configuration, rather than illustrating the details of the design. The present shock absorbers are configured to be primarily used with a pedaled bicycle, such as the bicycle 150. The device could be used with a powered bicycle, a motorcycle, a moped, or similar vehicle. The bicycle 150 may include a frame 152, a front wheel 154, and a rear wheel 156. The bicycle 150 may further include a drive system 158 that conventionally includes a first pedal 160 and a second pedal 162 positioned generally opposite one another. When a user uses motive power, the user alternately presses the first pedal 160 and the second pedal 162. Each of the first pedal 160 and the second pedal 162 are conventionally attached to a front chain ring 164. A conventional chain (not shown) transmits the driving force from the pedals 160, 162, through the front chain ring 164 to a rear chain ring (not shown). The rear chain ring is secured to the rear wheel 156, causing it to rotate about an axle passing therethrough (not shown) and thereby causing the bicycle 150 to move. The bicycle frame 152 conventionally allows for the attachment of a seat 166 that a user sits on when using the pedals 160 and 162. The bicycle frame 152 also conventionally includes a head 168. The head 168 allows for the attachment of handlebars 170 that further attach through the head 168 to a front fork 172.

The front fork 172 may conventionally have a first leg 174 that extends on one side 176 of the front wheel 154 and a second leg 178 that extends on an opposite side 180 of the front wheel 154. An axle 182 is configured to pass through a center of the front wheel 154 and an aperture in each of the first leg 174 and the second leg 178. Any conventional axle structure and attachment structure can be used with the present suspension system. The following FIGS. illustrate a conventional closed bore system that can be used with any conventional axle that attaches through a closed bore system. In another embodiment, the present disclosed embodiments could incorporate an open bore system, a partially closed bore system, or any other conventional system.

A rear shock 190 may also be incorporated into the bicycle 150. The rear shock 190 may be secured on one end to the frame 152 and on the other end to an appropriate structure that is further secured to the rear wheel 156 to absorb impact force affecting the rear wheel.

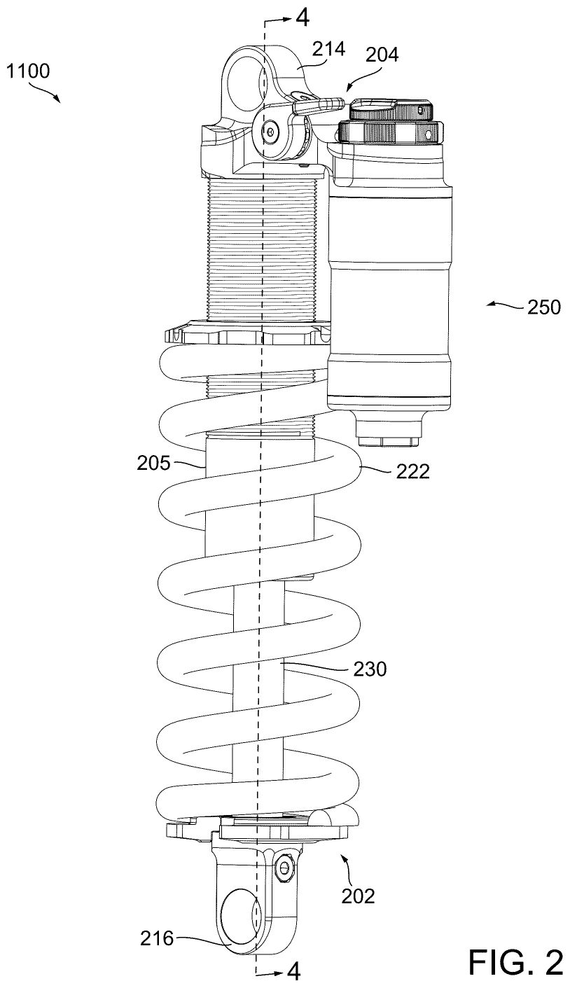

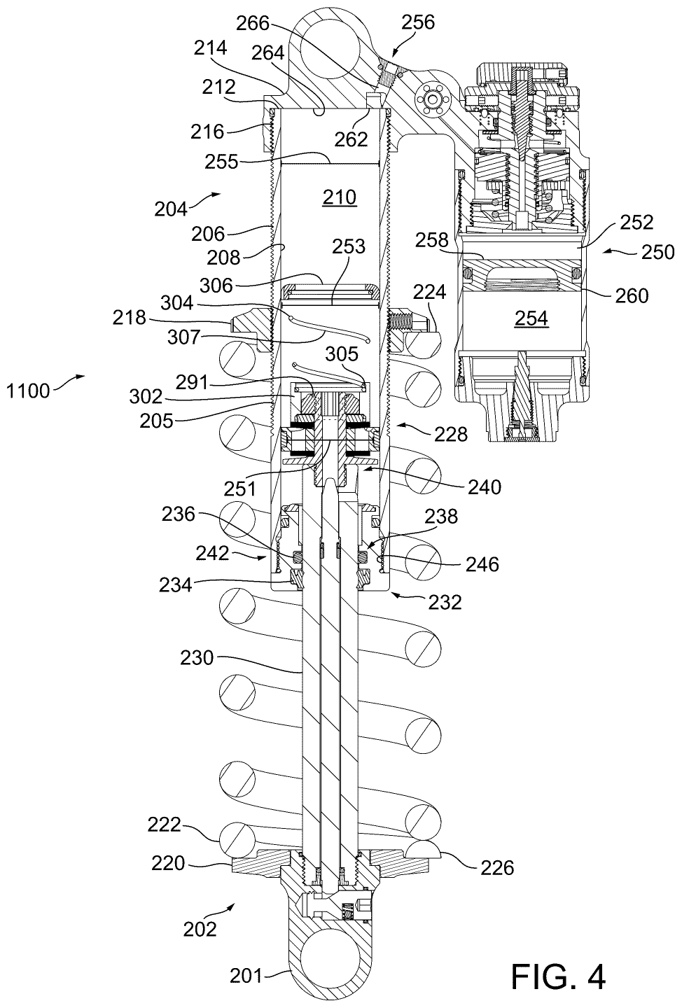

Turning now to one embodiment, a rear shock absorber 1100, as initially seen in FIGS. 2 and 4, may include a first end 202 and a second end 204. The second end 204 may be capable of telescopically reciprocating with the first end 202. The second end 204 may include a tube 205. The tube 205 may have an exterior surface 206 and an interior surface 208. The interior surface 208 may form a wall of a first chamber, which may be the compression chamber 210. A first free end 212 of the tube 205 may be secured to a first end cap 214. In the embodiment of FIG. 4, the first free end 212 and the first end cap 214 may be threadably secured to one another using first threads 216. In other embodiments, the first end cap 214 may be secured to the tube 205 using any other conventional attachment structure. In some embodiments, the tube 205 and the first end cap 214 may be integrally formed.

A first stop 218 may be integrally formed with or secured to the exterior surface 206 of the tube 205. A second stop 220 may be integrally formed with or secured to the first end 202. A rebound spring 222 may have a first end 224 and a second end 226. The first end 224 may contact or be secured to the first stop 218. The second end 226 may contact or be secured to the second stop 220. As is conventional, the rebound spring 222 may be configured to resist compression of the shock absorber 1100 by resisting movement of the second stop 220 toward the first stop 218. The construction, placement, and features of the stops and the rebound spring are conventional and well known to persons of ordinary skill in the art and will not be described in further detail.

As is also conventional, the first end 202 may further include a piston or piston assembly 228 that may be substantially fixedly attached to a shaft 230 that may be further fixed to the first bracket 201. The piston 228 may therefore be fixed in location relative to the first bracket 201. The piston 228 and shaft 230 may be configured to be assemblies and to have a variety of parts that are well known by persons of ordinary skill in the art. The selection and arrangement of somewhat different parts to achieve similar functions will be understood to fall within the scope of this disclosure. The piston 228 and the shaft 230 may be configured to reciprocate within the second end. The rebound spring 222 may be configured to substantially surround at least a portion of the shaft 230 and the piston 228 in many available positions of the shaft 230 and the piston 228.

To assemble the structure, the tube 205 and the end cap 214 may be assembled together. The shaft 230 and the first end 201 may be assembled together. Then the medial cap assembly 232 may be placed on the shaft 230. In many embodiments, a conventional wipe seal 234 and a conventional seal 236 may be positioned on an interior circumference 238 of the medial cap assembly. The conventional wipe seal 234 may minimize the intrusion of particulate matter into the tube 205 and the conventional seal 236 may be a fluid barrier to minimize the intermingling of fluid within the tube 205 and fluid outside the tube 205. The piston assembly 228 may then be secured adjacent the free end 240 of the shaft 230. The piston assembly 228 may then be inserted into the tube 205 and the medial cap assembly 232 may be positioned adjacent the second free end 242 of the tube 205. In some embodiments, the medial cap assembly 232 may be secured to the tube 205 using threads 246 or any other alternative attachment structure deemed appropriate by the designer. Once fully assembled, the compression chamber 210 may be substantially formed by the medial cap 232, the end cap 214, and the tube 205.

The shock absorber 1100 may further include a reservoir system 250. In many embodiments, the reservoir system 250 may include a second chamber, which may be a reservoir chamber 252, and a third chamber, which may be a compensator chamber 254 separated from the second chamber 252 by a floating piston 260.

In many embodiments, the compression chamber 210 may be in fluid communication with the reservoir chamber 252. In such embodiments, during a compression stroke, fluid in the compression chamber 210 may flow through a barrier assembly 256 and into the reservoir chamber 252. In many embodiments, the fluid in the compression and reservoir chambers may be an incompressible fluid. As fluid flows from the compression chamber 210, through the barrier assembly 256 and into the reservoir chamber 252, pressure in the reservoir chamber 252 may rise. This pressure increase may also increase the force on a first face 258 of the floating piston 260. This increased force may move the floating piston 260 into the compensator chamber 254. In many embodiments, the compensator chamber 254 may be substantially filled with a compressible fluid. The use of this type of compensator chamber to minimize the risk of cavitation and create adequate pressure in the reservoir chamber 252 and compression chamber 210 is well known by persons of skill in the art and therefore will not be described in detail herein.

The barrier assembly 256 may include at least one hole or aperture 262 in at least one wall of the compression chamber 210. In the embodiment of FIG. 4, the at least one hole 256 may be made in a wall 264 formed by the end cap 214. The at least one aperture 262 may be an opening to at least one flow route 266 that may extend between the compression chamber 210 and the reservoir chamber 252. Fluid may be permitted to flow between the compression chamber 210 and the reservoir chamber 252 by flowing through the at least one aperture 262 and the at least one flow route 266. In many embodiments, the at least one aperture 262 may be circular or substantially circular. In the illustrated embodiments, the at least one flow route is shown as a passageway through an end cap and into the reservoir chamber. A person of ordinary skill in the art is able to substitute another style of flow route, such as a tube that connects to a remote reservoir or any other desirable configuration. In addition, while the reservoir chamber is shown as being adjacent the compression chamber, the reservoir chamber may alternatively be aligned with the compression chamber.

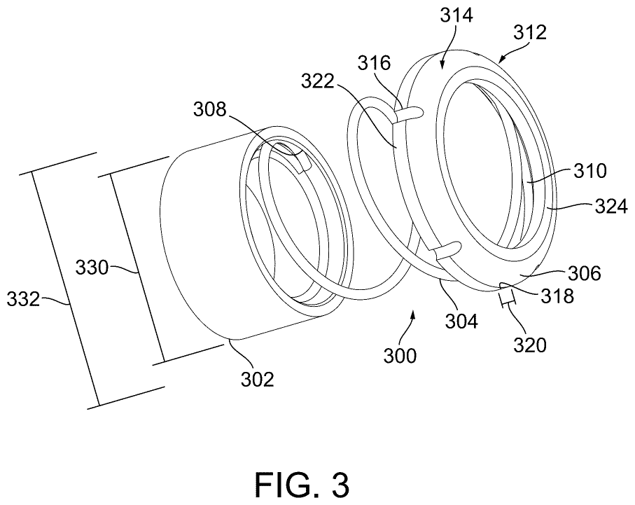

In many embodiments, additional structures may be used to regulate or affect fluid flow through the barrier assembly 256. One embodiment of a flow regulator 300 is shown in FIG. 3. The flow regulator embodiment of FIG. 3 may include a spring retainer 302, a spring 304, and a blocker 306. As may be seen most clearly in an examination of FIGS. 3 and 4, the spring retainer 302 may be attached to the piston assembly 228. A first end 308 of the spring 304 may be attached to the spring retainer 302. A second end 310 of the spring 304 may be attached to the blocker 306. Any conventional attachment structure may be used to attach the spring 304 to the spring retainer 302 and the blocker 306. A person of ordinary skill in the art may be able to select an appropriate attachment design among conventional attachment designs based on the size, shape, and materials selected. Accordingly, this attachment is not described herein.

In some embodiments, the flow regulator 300 may be modular. Different configurations of flow regulators may be used within a shock absorber 1100, depending on the flow conditions desired by a designer or a rider. Accordingly, the spring retainer 302 may be removably attached to the piston assembly 228.

In some embodiments, the blocker 306 may include a blocking face 312. The blocking face 312 may include a taper or be radiused, such as is shown at 314. The taper or radius may extend between at least a portion of an outer or peripheral edge 322 of the blocker and a bottom 324 of the blocker 306. In addition, the blocker 306 may include inlets 316 to govern the volume and rate of fluid flow along the inlets and rate of flow around and through the blocker 306.

In many embodiments, the size and shape of the interior surface 208 of the tube 205 may be closely matched to the size and shape of the exterior surface 318 of the blocker 306, as may be best seen in FIG. 4. In this embodiment, the piston 228 may have a diameter 251. The blocker 306 may have a diameter 253. The compression chamber 210 may have a diameter 255. In many embodiments, the diameter 251 of the piston 228 may be the same, substantially the same as, or substantially equal to the diameter 253 of the blocker 306 and the diameter 255 of the compression chamber 210. In many such embodiments, it may be desirable for the blocker 306 to slide substantially coaxially with the shaft 230 along the interior surface 208 of the tube 205. This coordination of the structures minimizes torsion and co-axial deviation between the tube 205 and the blocker 306. In many embodiments, the thickness 320 of the outer or peripheral edge or profile 322 of the blocker 306 may be selected to minimize the risk of misalignment of the blocker 306 within the tube 205. Such a configuration may allow the peripheral edge 322 of the blocker 306 to contact a wall of the compression chamber 210, such as the interior surface 208 of the tube 205.

Some functions of the flow regulator 300 may be best seen in comparing the different positions of the flow regulator 300 in FIGS. 4-7. As will be apparent to one of ordinary skill in the art, and as is conventional, the piston assembly 228, during a compression stroke, may move within the second end 204. More specifically, the piston assembly 228 may enter into the compression chamber 210. The end face 291 of the piston assembly 228 may press against and thereby may move some or all of the substantially incompressible fluid from the compression chamber 210, through the at least one aperture 262, through the at least one flow route 266, and into the reservoir chamber 252. During most of the compression stroke, such as the positions similar to that in FIG. 4, the flow of fluid may be unaffected by the flow regulator 300.

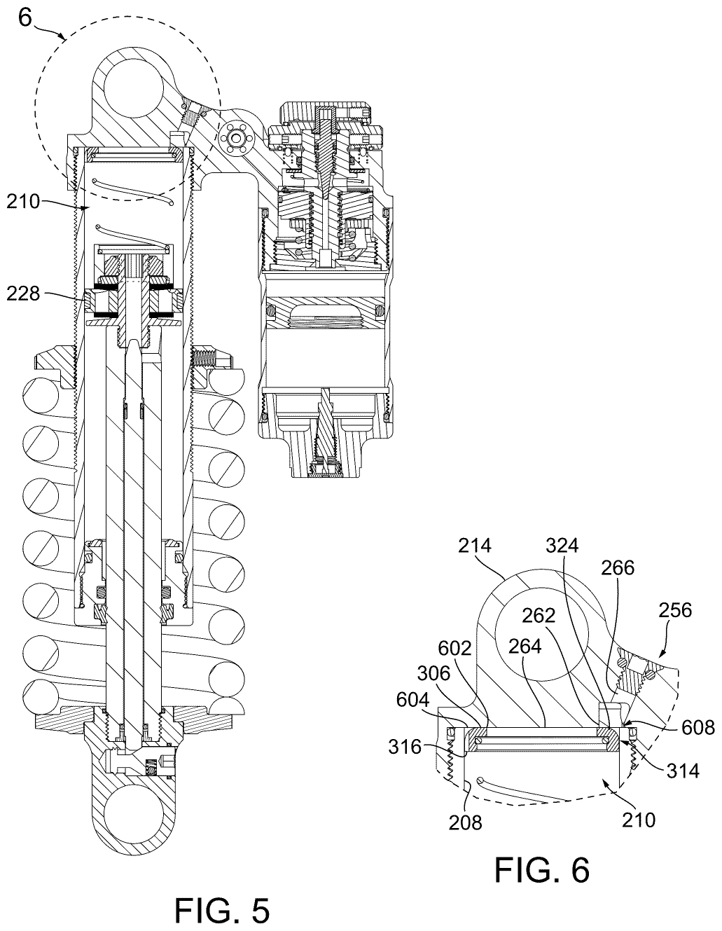

Looking at FIGS. 5 and 6, when the piston assembly 228 reaches a particular portion of the stroke, the blocker 306 may contact a stop surface 602 in the compression chamber 210 and affect the fluid flow during a portion of the stroke. In the embodiment of FIGS. 2-7, the stop surface 602 may be a particular position on the inner surface or wall 264 that may be formed by the end cap 214. The blocker 306 may move within the compression chamber 210. However, the stop surface 602 may define an extreme position of the blocker 306, past which it may go no further in that direction.

As may be seen most clearly in the enlarged view of FIG. 6, when the blocker 306 contacts the stop surface 602, the structure of the blocker 306 may affect fluid flow so that fluid may no longer be able to freely flow from the compression chamber 210, through the at least one aperture 262 and into the at least one flow route 266. Indeed, a portion of the bottom 324 of the blocker 306 may overlap and thereby at least partially obstruct the at least one aperture 262. However, some fluid may still be able to flow through the at least one aperture 262 after the blocker 306 reaches the position in FIGS. 5 and 6. As was described in connection with FIG. 3, fluid may be able to flow through the inlets 316 and into a fluid passageway 604 defined between the radiused or tapered portion 314 of the blocker 306, and one or more walls of the compression chamber 210. In the illustrated embodiment, the fluid passageway 604 may be defined by the radiused portion 314, the inner surface 208 of the tube 205, and the end face 264. The blocker 306 thereby may affect fluid flow through the barrier assembly 256 by restricting fluid flow through the barrier assembly 256. In the embodiment illustrated in FIGS. 5 and 6, the fluid flow may be permitted only adjacent a peripheral area 608 of the blocker 306.

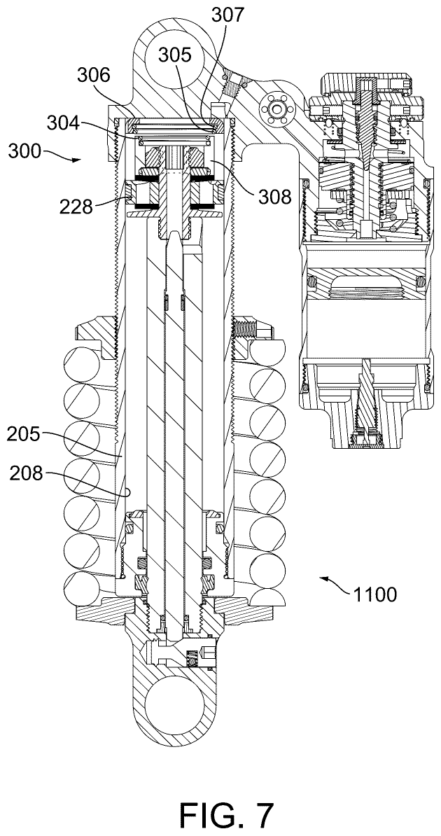

Turning now to FIG. 7, an extreme compressed position of the shock absorber 1100 is shown. While it is desirable for shock absorbers, like shock absorber 1100, to have structures that minimize the risk of harsh bottom out, it is also desirable for the shock absorber to have the greatest distance of travel. Accordingly, when a flow adjuster 300 is incorporated into the design, it is desirable that the flow adjuster 300 be configured to occupy as little length as possible. As noted earlier, the thickness 320 of the blocker 306 may have a desirable minimum length to minimize any deviation in its angle when sliding along the interior surface 208 of the tube 205. It may be desirable for the spring 304 to also occupy a minimum longitudinal distance. It may also be desirable for the spring 304 to have a minimum diameter, strength and gauge to properly position the blocker 306. The spring 304 need not have a significant spring constant, because it is used primarily for spacing, not for forcing the blocker 306 against a fluid flow. The spring 304 may be primarily used to position the blocker 306 away from the piston assembly 228 and the spring retainer 302. The blocker 306 may thereby be spaced from the piston assembly 228. However, an exact position of the blocker 306 relative to the spring retainer 302 is not critical. The size and material of the spring 304 may be selected to minimize the effect of the spring 304 on the flow of the substantially incompressible fluid within the compression chamber 210 while still maintaining an appropriate position of the blocker 306 relative to the piston assembly 228. Further, in many embodiments, it may be desirable for the end surface 324 of the blocker 306 to be configured to be as small as possible to minimize its effect on the flow of fluid within the compression chamber 210 and to minimize the compression of the spring 304 due to force on the blocker 306 from the substantially incompressible fluid within the compression chamber 210.

In the illustrated embodiments, a single hole 262 in the end face 264 is illustrated that may be partially or completely blocked by the blocker 306. In alternative embodiments, more than one hole may be used, and the blocker may block or partially block one or fewer than all the holes, rather than blocking or partially blocking all the holes. In the illustrated embodiment of FIGS. 2-7, the fluid passageway may be defined between an outer periphery of the blocker 306 and one or more of the walls of the compression chamber 210, thereby blocking an inner portion of the hole. In another embodiment, the fluid passageway may be between the blocker and the face of the end cap, and the blocker may partially block an outer portion of the hole.

In many embodiments, it may be desirable for the spring 304 to be tapered. In many embodiments, as may be best seen in FIG. 3, the spring 304 may have a first diameter 330 at the spring retainer 302 and a second diameter 332 at the blocker 306. The first diameter 330 may be smaller than the second diameter 332. The use of a taper may allow two or more of the loops 305, 307 of the spring 304 to partially or completely nest inside one another in a fully compressed position near that shown in FIG. 7. The tapering of the spring 304 may allow the loops of the spring 304 to be positioned at least partially laterally relative to one another when compressed, rather than stacking fully longitudinally as is the case with an untapered spring. In the illustrated embodiment, the diameter of the spring 304 may be narrowest near the spring retainer 302 and greater near the blocker 306, but this could be configured in another manner. Such a taper may allow for the blocker 306 to have a minimum gauge, size and shape to reduce weight. The at least partial nesting of the spring loops may allow the piston assembly 228 to have a maximum travel length, without the available length being shortened by the spring 304.

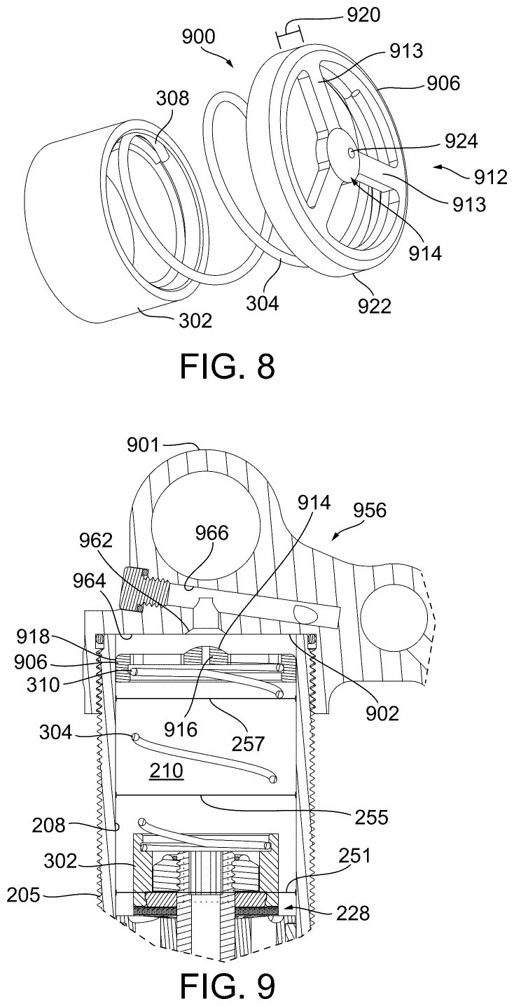

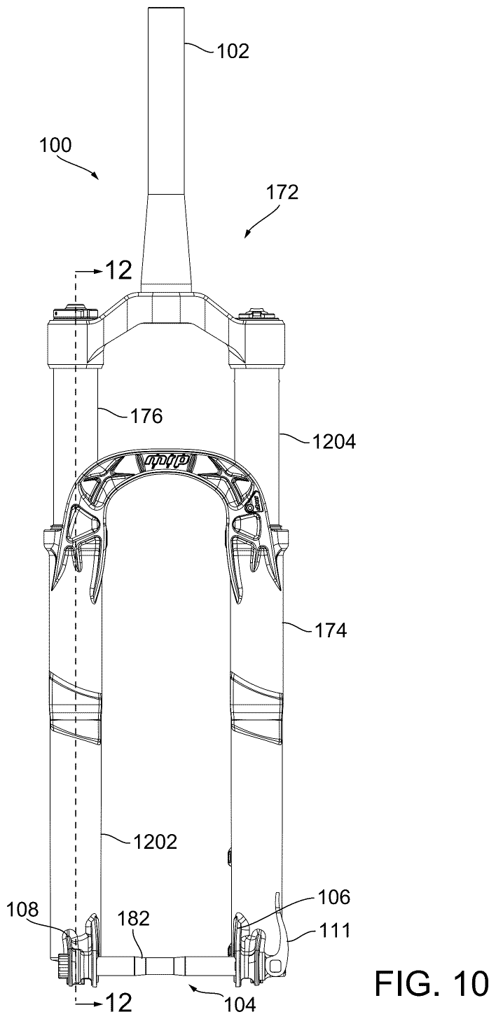

An alternative embodiment for a rear shock is shown in FIGS. 8 and 9. In the embodiment shown, the blocker 906 of FIGS. 8 and 9 is substituted for the blocker 306 in FIGS. 2-7 and the barrier assembly 956 of FIGS. 8 and 9 is substituted for the barrier assembly 256 in FIGS. 2-7.

During a compression stroke, fluid in the compression chamber 210 may flow through the barrier assembly 956 and into the reservoir chamber 252 (not shown in these FIGS.). In many embodiments, the fluid in the compression 210 and reservoir 252 chambers may be an incompressible fluid.

The barrier assembly 956 may include at least one hole or aperture 962 in at least one wall 964 of the compression chamber 210. In the embodiment of FIG. 9, the at least one hole 962 may be made in a wall 964 formed by the end cap 901. The at least one aperture 962 may be an opening to at least one flow route 966 that may extend between the compression chamber 210 and the reservoir chamber 252. Fluid may be permitted to flow between the compression chamber 210 and the reservoir chamber 252 by flowing through the at least one aperture 962 and the at least one flow route 966. In many embodiments, the at least one aperture 962 may be circular or substantially circular.

In many embodiments, additional structures may be used to affect fluid flow through the barrier assembly 956. One embodiment of a flow regulator 900 is shown in FIG. 8. The flow regulator embodiment of FIG. 8 may include a spring retainer 302, a spring 304, and a blocker 906. As may be seen most clearly in FIG. 9, the spring retainer 302 may be attached to the piston assembly 228. A first end 308 of the spring 304 may be attached to the spring retainer 302. A second end 310 of the spring 304 may be attached to the blocker 906. Any conventional attachment structure may be used to attach the spring 304 to the spring retainer 302 and the blocker 906. A person of ordinary skill in the art may be able to select an appropriate attachment design among conventional attachment designs based on the size, shape, and materials selected. Accordingly, this attachment is not described herein.

In some embodiments, the blocker 906 may include a blocking face 912. The blocking face 912 may include a taper or be radiused, such as is shown at 914. The taper or radius may extend between arms 913 of the blocker 906 and a bottom 924 of the blocker 906. In addition, the blocker 906 may include at least one inlet 916 to govern the volume and rate of fluid flow along the inlet 916 and the flow around and through the blocker 906.

In many embodiments, the size and shape of the interior surface 208 of the tube 205 may be closely matched to the size and shape of the exterior surface 922 of the blocker 906. In this embodiment, the piston 228 may have a diameter 251. The blocker 906 may have a diameter 257. The compression chamber 210 may have a diameter 255. In many embodiments, the diameter 251 of the piston 228 may be the same, substantially the same as, or substantially equal to the diameter 257 of the blocker 906 and the diameter 255 of the compression chamber 210. In many such embodiments, it may be desirable for the blocker 906 to slide coaxially along the interior surface 208 of the tube 205. This coordination of the structures may minimize torsion and co-axial deviation between the tube 205 and the blocker 906. In many embodiments, the thickness 920 of the outer edge or profile 922 of the blocker 906 may be selected to minimize the risk of misalignment of the blocker 906 within the tube 205. Such a configuration may allow the peripheral edge 922 of the blocker 906 to contact at least one wall of the compression chamber 210, such as the interior surface 208 of the tube 205.

Looking at FIG. 9, when the piston assembly 228 reaches a particular portion of the stroke, the blocker 906 may contact a stop surface 902 in the compression chamber 210. In the embodiment of FIG. 9, the stop surface 902 may be a particular position on the inner surface or wall 964 that may be formed by the end cap 901. The blocker 906 may move within the compression chamber 210. However, the stop surface 902 may define an extreme position of the blocker 906, past which it may go no further in that direction.

When the blocker 906 contacts the stop surface 902, fluid may be no longer able to freely flow through the at least one aperture 962 and into the at least one flow route 966. Indeed a portion of the bottom 924 of the blocker 906 may overlap and thereby partially obstruct the at least one aperture 962. However, fluid may still be able to flow after the blocker 906 reaches the at least one aperture 962. Fluid may be able to flow through the inlet 916 which forms a fluid passageway within the blocker 906. The blocker 906 thereby may affect fluid flow during at least a portion of the stroke through the barrier assembly 956 by restricting fluid flow through the barrier assembly 956.

Many of the features of the embodiment of FIGS. 2-7 apply to the embodiment of FIGS. 8 and 9. For those features having a common number, the features may be substantially identical. For those features that are not mentioned in connection with the embodiment of FIGS. 8 and 9, a person of ordinary skill in the art will appreciate that the features in both embodiments are substantially the same.

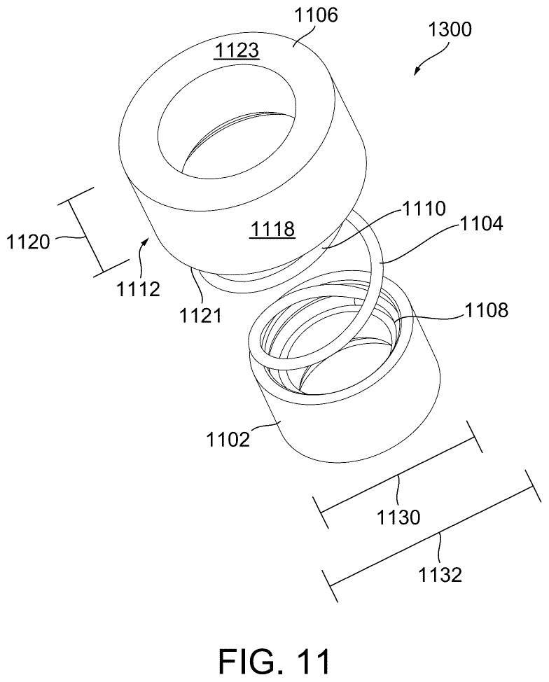

The blocker design may also be modified to be incorporated into a front fork. The shock absorbing fork or suspension 100, as initially seen in FIG. 10 and continuing in FIGS. 11-14, may include a first end 1202 and a second end 1204. The second end 1204 may be capable of telescopically reciprocating with the first end 1202. The second end 1204 may include a tube 1205. The tube 1205 may have an exterior surface 1206 and an interior surface 1208. The interior surface 1208 may form a wall of a compression chamber 1210. A first free end 1212 of the tube 1205 may be secured to a first end cap 1214. In this embodiment, the first free end 1212 and the first end cap 1214 may be threadably secured to one another. In other embodiments, the first end cap 1214 may be secured to the tube 1205 using any other conventional attachment structure.

As is also conventional, the first end 1202 may further include a piston or piston assembly 1228 that may be substantially fixedly attached to a shaft 1230 that may be further fixed to the second end cap 1201. The piston 1228 therefore may be fixed in location relative to the end cap 1201. The piston 1228 and shaft 1230 may be configured to be assemblies and to have a variety of parts that are well known by persons of ordinary skill in the art. The selection and arrangement of somewhat different parts to achieve similar functions will be understood to fall within the scope of this disclosure. The piston 1228 and the shaft 1230 may be configured to reciprocate within the second end 1204.

The shock absorber 100 may further include a reservoir system 1250. In many embodiments, the reservoir system may include a reservoir chamber 1252 and a compensator chamber 1254 separated by a floating piston 1260.

In many embodiments, the compression chamber 1210 may be in fluid communication with the reservoir chamber 1252. In these embodiments, during a compression stroke, fluid in the compression chamber 1210 may flow through a barrier assembly 1256 and into the reservoir chamber 1252. In many embodiments, the fluid in the compression 1210 and reservoir 1252 chambers may be an incompressible fluid. As fluid flows from the compression chamber 1210, through the barrier assembly 1256 and into the reservoir chamber 1252, pressure in the reservoir chamber 1252 may rise. This pressure increase may also increase the force on a first face 1258 of a floating piston 1260. This increased force may move the floating piston 1260 into the compensator chamber 1254. In many embodiments, the compensator chamber 1254 may be substantially filled with a compressible fluid. The use of this type of compensator chamber to minimize the risk of cavitation and create adequate pressure in the reservoir chamber 1252 and compression chamber 1210 is well known by persons of skill in the art and therefore will not be described in detail herein.

The barrier assembly 1256 may include one or more holes or apertures 1262, 1263 in at least one wall of the compression chamber 1210. In this embodiment, it may be desirable to have a first at least one aperture 1262 longitudinally separated from a second at least one aperture 1263 along the interior surface 1208 of the compression chamber 1210. The apertures 1262, 1263 may be openings to a flow route 1266 that extends between the compression chamber 1210 and the reservoir chamber 1252. Fluid may be permitted to flow between the compression chamber 1210 and the reservoir chamber 1252 by flowing through the apertures 1262, 1263 and the flow route 1266. In many embodiments, the apertures 1262, 1263 may be circular or rounded.

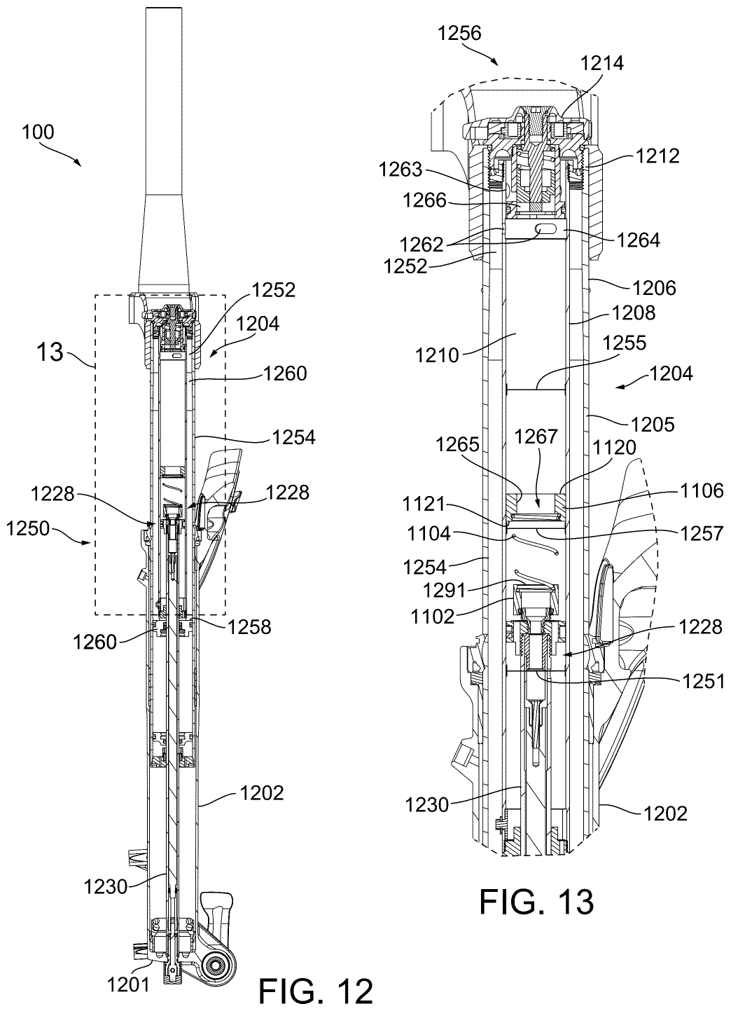

In many embodiments, additional structures may be used to affect fluid flow through the barrier assembly 1256. One embodiment of a flow regulator 1300 is shown in FIG. 11. The flow regulator embodiment of FIG. 11 may include a spring retainer 1102, a spring 1104, and a blocker 1106. As may be seen most clearly in an examination of FIGS. 12 and 13, the spring retainer 1102 may be attached to the piston assembly 1228. A first end 1108 of the spring 1104 may be attached to the spring retainer 1102. A second end 1110 of the spring 1104 may be attached to the blocker 1106. Any conventional attachment structure may be used to attach the spring 1104 to the spring retainer 1102 and the blocker 1106. A person of ordinary skill in the art may be able to select an appropriate attachment design among conventional attachment designs based on the size, shape, and materials selected. Accordingly, this attachment is not described herein.

In some embodiments, the flow regulator 1300 may be modular. Different configurations of flow regulators may be used within a shock absorber 100, depending on the flow conditions desired by a designer or a rider. Accordingly, the spring retainer 1102 may be removably attached to the piston assembly 1228.

In some embodiments, the blocker 1106 may include a blocking face 1112. The blocking face 1112 may be substantially flat, as is shown, or may include a taper or be radiused. In addition, the blocker 1106 may include inlets to govern the volume and rate of fluid flow along the inlets and around and through the blocker 1106. The blocker 1106 may also include an end face 1123.

In many embodiments, the size and shape of the interior surface 1208 of the tube 1205 may be closely matched to the size and shape of the exterior surface 1118 of the blocker 1106, as may be best seen in FIG. 13. In this embodiment, the piston 1228 may have a diameter 1251. The blocker 1106 may have a diameter 1257. The compression chamber 1210 may have a diameter 1255. In many embodiments, the diameter 1251 of the piston 1228 may be the same, substantially the same as, or substantially equal to the diameter 1257 of the blocker 1106 and the diameter 1255 of the compression chamber 1210. In many such embodiments, it may be desirable for the blocker 1106 to slide coaxially with the shaft 1230 along the interior surface 1208 of the tube 1205. This coordination of the structures may minimize torsion and co-axial deviation between the tube 1205 and the blocker 1106. In many embodiments, the thickness 1120 of the outer edge or profile 1118 of the blocker 1106 may be selected to minimize the risk of misalignment of the blocker 1106 within the tube 1205. Such a configuration may allow the peripheral edge 1118 of the blocker 1106 to contact a wall of the compression chamber 1210, such as the interior surface 1208 of the tube 1205.

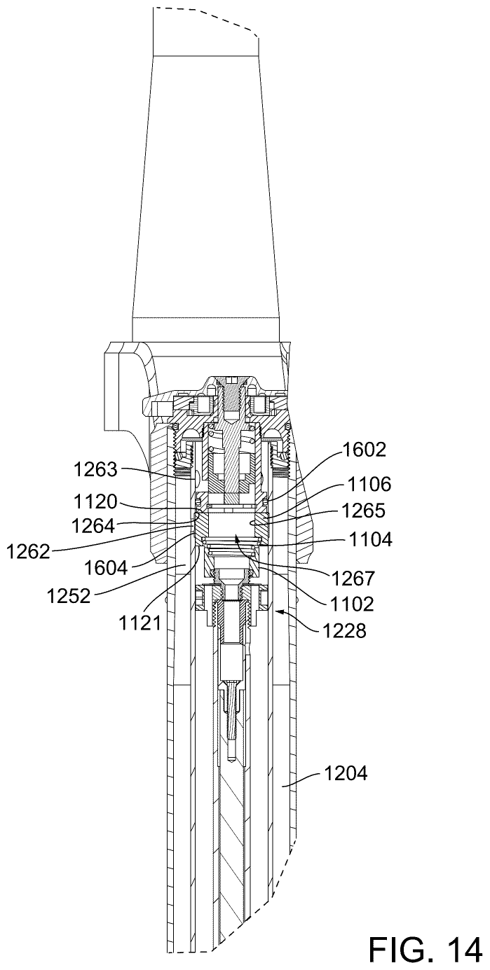

Some functions of the flow regulator 300 may be best seen in comparing the flow regulator positions in FIGS. 13 and 14. As will be apparent to one of ordinary skill in the art, and as is conventional, the piston assembly 1228, during a compression stroke, may move within the second end 1204. More specifically, the piston assembly 1228 may enter into the compression chamber 1210. The end face 1291 of the piston assembly 1228 may press against the incompressible fluid and thereby may move the substantially incompressible fluid from the compression chamber 1210, through the at least one aperture 1262, through the at least one flow route 1266, and into the reservoir chamber 1252. During most of the compression stroke, such as the positions similar to that in FIG. 13, the flow of fluid may be unaffected by the flow regulator 1300. However, the flow regulator 1300 may affect the fluid flow during a portion of the stroke.

Looking at FIG. 14, when the piston assembly 1228 reaches a particular portion of the stroke, the blocker 1106 may contact a stop surface 1602 in the compression chamber 1210. In the embodiment of FIGS. 10-14, the stop surface 1602 may be a particular position on the inner surface or wall 1264 that may be formed by the end cap 1214. The blocker 1106 may move within the compression chamber 1210. However, the stop surface 1602 may define an extreme position of the blocker 1106, past which it may go no further in that direction.

As may be seen most clearly in FIG. 14, when the blocker 1106 contacts the stop surface 1602, fluid may no longer be able to flow through the first at least one aperture 1262 and into the at least one flow route 1266. Indeed at least a portion of the outer side 1118 of the blocker 1106, such as the blocking surface 1112, may overlap and thereby obstruct the first at least one aperture 1262. In many embodiments, it may be desirable for the outer side 1118 of the blocker 1106 to minimize or substantially prevent fluid from flowing through the first at least one aperture 1262 when the blocker 1106 reaches the position in FIG. 14. When the first at least one aperture 1262 becomes blocked, fluid in the compression chamber 1262 may flow through a fluid passageway 1265 in the central area 1267 of the blocker 1106. The fluid may then flow through the second at least one aperture 1263, and through the flow route 1266 to the reservoir chamber 1252.

As shown in the embodiment of FIGS. 10-14, the length of a flow route may be determined by the proximity of the compression chamber and the reservoir chamber. In the embodiments of FIGS. 2-9, the compression chamber and the reservoir chamber were remote from one another and a relatively longer flow route may be necessary. In a configuration like that in FIGS. 10-14, the compression chamber and the reservoir chamber may be separated by a small distance and the reservoir chamber may be annularly positioned around the compression chamber. In such a configuration, it will be understood by a person of ordinary skill in the art that a respective aperture, like the apertures 1262, 1263 may be defined in the compression chamber 1210. Each aperture 1262, 1263 may have a relatively short flow route associated with each respective aperture 1262, 1263 that independently flows directly into the reservoir chamber 1252.

Turning now to FIG. 14, an extreme compressed position of the shock absorber 1100 is shown. While it is desirable for shock absorbers, like shock absorber 1100, to have structures that minimize the risk of harsh bottom out, it is also desirable for the shock absorber to have the greatest distance of travel. Accordingly, when a flow adjuster 1300 is incorporated into the design, it may be desirable that it be configured to occupy as little length as possible. As noted earlier, the thickness 1120 of the blocker 1106 may have a desirable minimum length to minimize any deviation in its angle when sliding along the interior surface 1208 of the tube 1205. It may also be desirable for the spring 1104 to occupy a minimum longitudinal distance. It may be desirable for the spring 1104 to have a minimum diameter, strength and gauge. Because the spring 1104 need not hold the blocker 1106 or the spring retainer 1102 against another flow, the spring 1104 need not have a significant spring constant. The spring 1104 may be primarily used to position the blocker 1106 away from the piston assembly 1228 and the spring retainer 1102. However, an exact position of the blocker 1106 relative to the spring retainer 1102 may not be critical. The size and material of the spring 1104 may be selected to minimize the effect of the spring 1104 on the flow of the substantially incompressible fluid within the compression chamber 1210, while still maintaining an appropriate position of the blocker 1106 relative to the piston assembly 1228. The blocker 1106 may thereby be spaced from the piston assembly 1228.

In many embodiments, it may be desirable for the spring 1104 to be tapered. In many embodiments, as may be best seen in FIG. 11, the spring 1104 may have a first diameter 1130 at the spring retainer 1102 and a second diameter 1132 at the blocker 1106. The first diameter 1130 may be smaller than the second diameter 1132. The use of a taper may allow the loops of the spring 1104 to partially or completely nest inside one another in a fully compressed position near that shown in FIG. 14. The tapering of the spring 1104 may allow two or more of the loops of the spring 1104 to be positioned at least partially laterally relative to one another when compressed. In the illustrated embodiment, the diameter of the spring 1104 may be narrowest near the spring retainer 1102 and greater near the blocker 1106 but could be configured in another manner. Such a taper may allow for the blocker 1106 to have a minimum size and shape to reduce weight. The nesting of the spring loops may allow the piston assembly 1228 to have a maximum travel length, without the available length being shortened by the spring.

This detailed description in connection with the drawings is intended principally as a description of the presently preferred embodiments of the invention and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A suspension for a vehicle, comprising:
a first end including a piston;
a second end capable of telescopically reciprocating with the first end and at least partially defining a compression chamber having at least one wall;
a barrier assembly between the compression chamber and a reservoir chamber;
a spring attached to the piston; and
a blocker attached to the spring,
wherein the blocker at least partially defines at least one fluid passageway; and
wherein the blocker has a peripheral edge configured to contact the at least one wall of the compression chamber.

2. The suspension according to claim 1, wherein the barrier assembly comprises at least one aperture defined in at least one wall of the compression chamber.

3. The suspension according to claim 2, wherein the barrier assembly further comprises at least one flow route between the at least one aperture and the reservoir chamber.

4. The suspension according to claim 3, wherein fluid is permitted to flow between the compression chamber and the reservoir chamber by flowing through the at least one aperture and the at least one flow route.

5. The suspension according to claim 1, wherein the blocker has a diameter, the piston has a diameter, and the compression chamber has a diameter, and the diameter of the blocker, the diameter of the piston, and the diameter of the compression chamber are substantially equal.

6. The suspension according to claim 1, wherein the peripheral edge of the blocker has a height adequate to minimize co-axial deviation of the blocker relative to the corresponding wall of the compression chamber.

7. The suspension according to claim 1, wherein the spring is tapered.

8. The suspension according to claim 1, further comprising a spring retainer between the spring and the piston.

9. The suspension according to claim 8, wherein the spring retainer is removable from the piston.

10. The suspension according to claim 1, further comprising a stop surface in the compression chamber that defines an extreme position for the blocker.

11. A suspension for a vehicle, comprising:
a first end including a piston;
a second end capable of telescopically reciprocating with the first end and at least partially defining a first chamber;
a tapered spring attached to the piston, the tapering of the spring allowing at least two loops of the tapered spring to be positioned at least partially laterally relative to one another when compressed; and
a blocker spaced from the piston and attached to the spring.

12. The suspension according to claim 11, further comprising a second chamber in fluid communication with the first chamber.

13. The suspension according to claim 12, further comprising a barrier assembly that at least partially defines the fluid communication between the first chamber and the second chamber.

14. The suspension according to claim 13, wherein the barrier assembly comprises an aperture defined in at least one wall of the first chamber.

15. The suspension according to claim 13, wherein the barrier assembly further comprises at least one flow route between the aperture and the second chamber.

16. The suspension according to claim 11, wherein the blocker has a peripheral edge configured to contact at least one wall of the first chamber.

17. The suspension according to claim 16, wherein the peripheral edge of the blocker has a height adequate to minimize co-axial deviation of the blocker relative to the corresponding wall of the first chamber.

18. The suspension according to claim 16, wherein the blocker at least partially defines at least one fluid passageway that affects fluid flow through the barrier assembly.

19. The suspension according to claim 11, further comprising a spring retainer between the spring and the piston.

20. The suspension according to claim 11, wherein the blocker has a diameter, the piston has a diameter, and the first chamber has a diameter, and the diameter of the blocker, the diameter of the piston, and the diameter of the first chamber are substantially equal.
